(19) United States
(12) Patent Application Publication
(10) Pub. No.: US 2013/0194068 A1
(43) Pub. Date: Aug. 1, 2013

(54) METHOD FOR PROVIDING WIRELESS VEHICLE ACCESS

(71) Applicants: Stefan Mönig, Schwelm (DE); Veit Schröter, Essen (DE)

(72) Inventors: Stefan Mönig, Schwelm (DE); Veit Schröter, Essen (DE)

(21) Appl. No.: 13/816,683

(22) PCT Filed: Aug. 5, 2011
(86) PCT No.: PCT/EP11/63551

§ 371 Date: Apr. 15, 2013

(30) Foreign Application Priority Data
Aug. 16, 2010 (DE) 10 2010 037 013.4
Sep. 1, 2010 (DE) 10 2010 037 271.4

(51) Int. Cl. G08C 17/02

(52) U.S. Cl. CPC G08C 17/02
USPC 340/5.61

(57) ABSTRACT

To provide motor vehicle access, a connection is set up between an ID signal generator assigned to the vehicle and a wireless communication device. A first identification code, stored in the ID signal generator, is transmitted to the communication device. A connection is set up between the communication device and a service provider via a public communication network. The identification code is sent together with a second identification code which identifies the wireless communication device. A multi-part authorization message is generated by the service provider. Parts of the authorization message are sent to the communication device and parts transmitted to a control device in the vehicle. Access authorization of the communication device is checked on the basis of the part of the authorization message from the vehicle and the part from the communication device, via a connection between the communication device and the control device of the vehicle.

The invention relates to a method for setting up wireless vehicle access. In particular, the invention relates to a method, wherein authorisation for wireless vehicle access is transmitted from an ID signal generator associated with the vehicle to a separate device.

In most vehicles today, it is possible to access vehicle functions, e.g. unlocking a door or authorising the vehicle to start, by means of wireless communication between a means of authorisation, e.g. an ID signal generator, and a control device integrated into the vehicle.

To these ends, a device carried by the user accessing the vehicle contains identification data, which can be queried by the vehicle via a radio connection, and identify the user as a legitimate user. If access authorisation is verified in this manner, various vehicle functions can be enabled or disabled without requiring active intervention on the part of the user.

Moreover, the desire of users of motor vehicles to minimise the burden of carrying devices and keys for motor vehicles with them is recognised. On the other hand, the car keys and their functionality are practical tools for vehicle owners, especially in special cases (e.g. the transmitter battery is empty or giving temporary permission to a third party to access the vehicle).

The motor vehicle driver therefore wishes to authorise individual functions of the motor vehicle or, e.g. the everyday operation of the motor vehicle, through the use of devices that are carried by the user anyway. This may be, for example, mobile phones. At the same time, it must be ensured that security aspects are heeded, whereby the copying of a car key or ID signal generator with generally accessible means and without a trusted authorising agency is prevented.

The object of the invention is to facilitate the operation and authorisation of motor vehicle functions by means of available communications facilities.

This object is achieved according to the invention by the method having the features of patent claim 1.

In accordance with the method for providing wireless vehicle access as per the invention, a connection between an ID signal generator associated with the motor vehicle and a wireless communication device if first established. The wireless communication device can be any communication device, such as a mobile phone. It need only provide the means of communication aligned with the vehicle key in order to establish a radio link between the ID signal generator and the communication device. For the establishment of the connection, either common protocols and programs present on the communication device are executed or special programs are provided on the communication device to manage communications. To these ends, programs or applications, for example, can be loaded onto the communication device, which are programmed to communicate with appropriate ID signal generators. As part of the communication, an identification code stored in the ID signal generator is transmitted from the ID signal generator to the communication device. This stored identification code uniquely identifies the ID signal generator. The identification code may be stored in encrypted form on the ID signal generator, and also be transmitted via an encrypted connection to the wireless communication device. Furthermore, the encrypted identification code in the ID signal generator is transmitted in encrypted form to the communication device, so that they are not and cannot be decrypted in the communication device.

Subsequently, a connection via a conventional public communication network is established between the communication device and a service provider or an interface provided by the service provider. This connection can be established either via a mobile phone network or, for example, via the Internet. At its end, the service provider provides services and equipment that are accessible at any time for the establishment of a connection. In this regard, service providers are to be understood as all kinds of formal institutions that allow the receipt and processing of the transmitted data.

After the connection has been established, the first identification code, which was transmitted from the ID signal generator in the communication device, is transmitted to the service provider. Furthermore, an additional identification code is sent to the service provider, which in turn uniquely identifies the wireless communication device.

Both identification codes can be transmitted in encrypted form to prevent access to the data by unauthorised persons during transmission. If the identification code was transmitted in an already encrypted form from the ID signal generator to the communication device, this may encrypt the identification code again or forward it in the original encrypted form. Thus the communication device does not need knowledge of the true identification code, although this can also be possible.

The identification code provided by the ID signal generator is subject to authenticity and validity checks at the service provider's end. To do this, the service provider can utilise a database, which contains information on the identification codes of the ID signal generator. Such databases store the associations between ID signal generators and their associated vehicles.

Using the transmitted data, the service provider's system generates a multi-part authorisation message by means of a calculation process. This authorisation message is based on both the identifier code of the mobile wireless communication device and the identification code of the ID signal generator. Therefore, the multi-part authorisation message contains an association between these two identification codes.

The authorisation message contains data that are required by the vehicle for the granting of access to rights to the wireless communication device. Parts of these multi-part authorisation message are transmitted back to the wireless communication device, wherein any type of connection can be used. In particular, the previously utilised public communication network can be used, which has already been used to transmit data to the device.

Another part of the data is transmitted to a control device in the motor vehicle. The authorisation message is therefore transmitted in multiple parts along two different paths to two different target positions. In doing this, the parts transmitted to the respective target positions can contain matching segments, that is to say the data may intersect. Alternatively, entirely different pieces of data can be transmitted. The communication of the parts of the authorisation message to the motor vehicle or the control device in the motor vehicle is performed using any means of communication. If the motor vehicle is fitted with its own suitable means of communication, the transmission can be done directly. Alternatively, however, the transmission can be performed via an interposed trusted authority. Thus, for example, the portion of the authorisation message, which is intended for the control device in the motor vehicle, can be transmitted to a selectable car repair shop or vehicle dealer or another trusted authority (e.g. petrol station), which the user must have approached to allow these parts of the authorisation message to be transmitted to his or her vehicle. This step can then be carried out with further verification of the authorisation of the user and the associated wireless communication device.

After completion of such transmissions of the authorisation messages to both the wireless communication device and the control device in the motor vehicle, a connection can be established between these components and the authorisation of the communication device to access the motor vehicle can be verified on the part of the motor vehicle by means of the authorisation message, which is now available in its entirety. Only if the parts of the authorisation message match one another and verification is positive, is access to the motor vehicle by the wireless communication device configured and authorised. This access can extend to sub-functions or the complete functionality or even expanded functionality compared to the functionality of the identification transponder.

Generating the parts of the authorisation message may be accomplished by any method, however a tried and tested secure method for communication using distributed keys is especially applicable. Thus for example, a key pair can be generated by the service provider, and subsequently brought together via different communication channels and after the communication device has connected to the motor vehicle. Only if this key pair passes a logical test can the authorised and uncorrupted establishment of a connection be assumed. It may, for example, be a key pair, whereby a message to be decrypted is encrypted with a key and transmitted together with this key, and can only be decrypted with the other key, in order to verify the authorisation message (asynchronous encryption). Such concepts are known from various fields of technology, and have long been used, for example, in the area of encrypted communication.

Such an asymmetric encryption system can be used by the service provider to create a public key, which is sent to the communication device together with encrypted authorisation and to send the associated second private key to the motor vehicle. In this manner, the communication device can send messages encrypted with the public key to the motor vehicle, where they are decrypted with the private key. In addition to authentication, such a process can also be used to secure subsequent communication for commands.

Alternatively, however, a private key may also be stored in the motor vehicle during manufacture, with additional encryption if necessary. Such a secret key is known to the motor vehicle system, but also to the service provider, which has detailed information about the vehicle, similar to how a vehicle manufacturer has key data for the purpose of ordering additional keys. The availability of the information is usually protected by a dummy code, however as the identification code of the ID signal generator, is sent to the service provider, it is able to retrieve the appropriate key.

Therefore, a message and authorisation message to be decrypted with the private key can be sent by the service provider to the mobile communication device, as well as an authorisation message, which can also be decrypted with the private key and which is sent to the motor vehicle.

Within the scope of the invention, numerous other possibilities exist to secure the transmission of an authorisation message from the service provider to the two target sites, the communication means on the one hand, and the vehicle on the other hand.

Moreover, the service provider can also take other data into account in addition to the transmitted identification data of the key and communication device before the corresponding authorisation messages are generated. For example, it may be necessary for the vehicle owner to register in person with the service provider (e.g. via a web interface or a phone call) and register his or her mobile device for authentication. Only if such a registration is present can authorisation be performed within a time window.

It is essential for the execution of an authorisation and for the transmission of a corresponding authorisation message to the motor vehicle that there is provision for the interposition of a service provider, which holds a trusted position and additional data on the motor vehicle. Moreover, by this measure, the data is stored in a central location, which is advantageous in the case of revocation of authorisation, e.g. the loss of a mobile device.

According to the invention, the communication between the ID signal generator and the wireless communication device is configured such that a query of the relevant data of the ID signal generator can be effected only by means of communication aligned with the ID signal generator. Although in principle, a standardized communication protocol can be used, requests for the data at a higher protocol level can, however, be managed by the appropriate request software on the mobile device. This can prevent unauthorised access with standard devices being used to request the relevant information.

The connection between the ID signal generator and the wireless communication device is preferably a radio short-range radio connection, in particular a connection according to the NFC standard.

The NFC standard (Near Field Communication) is a short-range data transmission standard. The range of the NFC technology is only a few centimetres, thereby ensuring that no unwanted queries of a motor vehicle key can occur, e.g. if a conversation partner or a neighbour in a restaurant is also carrying a corresponding key. Moreover, according to the invention, user input on the ID signal generator can be required in order to enable any communication between the ID signal generator and the wireless communication device. The ID signal generator, correspondingly equipped with an NFC circuit, is placed in the vicinity of an NFC-enabled mobile communication device the transmission of the identification data from the ID signal generator to the mobile device can take place. There are already NFC-capable phones available on the market. This type of wireless technology is proven and established, and ideally suited for utilisation according to the invention for the transmission of identification messages.

Moreover, the overall concept and infrastructure of NFC technology can be used to implement the invention. Its standards can also be used for the invention. However, the invention can also be used with independent structures and proprietary standards or other established standards.

In a development of the invention, the connection between the wireless communication device and the control device in the vehicle is also a short-range connection, but here in particular a connection according to the Bluetooth standard. This type of connection is also a proven and established connection technology, with which vehicles are already equipped, either as a standard or optional feature. The Bluetooth connection has increased range compared to NFC radio technology and enables convenient connection of the mobile communication device with the motor vehicle in order to perform final authorisation.

In one refinement, after one-time positive authentication, the mobile communication device is assigned a unique identifier, which is stored in the vehicle-side control device and this mobile communication device is saved as permanently authorised. Such long-term authorisation can also be set up with an expiry time, so that after a certain length of time, e.g. some weeks, authorisation must be repeated or renewed. This method has the advantage that after completion of one permanent authorisation, network-independent and permanent access is provided to the motor vehicle without a regular authorisation connection between communication device and vehicle being necessary. Preferably, authorisation is only carried out successfully if the process is repeated several times within a predetermined minimum interval. For example, it is wise if the authorisation request must be repeated with identical devices with a minimum interval of several hours or days in order to increase security. This can rule out an unauthorised person, who briefly comes into possession of the ID signal generator, from performing authorisation. In all likelihood, the loss of the ID signal generator will be noticed in the specified time period and its loss reported, so that successful authorisation can be prevented.

It is particularly advantageous if parts of the authorisation message are transmitted from the service provider to the control device in the motor vehicle via a public mobile communications network. Many motor vehicles already have suitable mobile network communication devices, such as GSM/GPRS equipment. These communication channels can be used by the service provider to transmit the authorisation message to the motor vehicle. Existing structures are used to establish particularly convenient communication.

In an alternative configuration, the authorisation message is transmitted to the control device in the motor vehicle by using a service device that can be coupled with the control device. Such service devices can be installed at support points, such as gas stations and auto repair shops or car dealers, which carry out the coupling to the vehicle via the already existing service interface. The support point requests the parts of the authentication message associated with the vehicle and provided by the service provider, or these have already been provided to same in advance at the customer's request. The corresponding authorisation message can be transmitted to the motor vehicle by the service device using the service interface. It should be noted that this alone does not signify the authorisation of the communication device. Therefore, unlawful access to the vehicle—the creation of a duplicate key as it were—cannot be achieved using the service device alone. Instead, the interaction of all components, in particular the interposition of the service provider, is required.

In a preferred embodiment of the invention, an application provided by the service provider is accessed by or installed on the mobile communication device, and said application handles the entire verification process and authorisation communications. Such an application can be developed or provided by the service provider itself and can, for example, also be customised as required by the user to be restricted to communication with only one ID signal generator.

If the user of a motor vehicle thus requests the application from the service provider using his or her name and vehicle identification (e.g. chassis number), the application can be generated such that it is adapted to the specific ID signal generator and then transmitted to the user's wireless communication device. In this way, communication with several keys via a universally usable application can be prevented. For each key, a specific application would be generated and transmitted.

In a further development of the invention, prior to the establishment of a connection between the wireless communication device and a service provider via a public communication network, a master key is stored as a further identification code in the communication device, and this is transmitted, together with the first identifier and the second identifier of the wireless communication device to the service provider.

A master key that can be stored in a safe place separately from the vehicle key, increases the security of the method. The master key, similar to a PUK on a mobile phone card, is not carried in everyday use of the vehicle, but is only required for exceptional authorisation processes. Such further identification prevents the risk of creation of a copy in the case of wrongful appropriation of the key. The service provider provides the authorisation message only if the master key, which is known to the service provider as well as the identification of the key, is correctly transmitted.

Preferably, the process also verifies that the establishment of the connection between the wireless communication device and the control device of the motor vehicle takes place within a predetermined time period from the transmission of the identification data from the wireless communication device to the service provider.

The inclusion of time as a limiting parameter in the process increases the security. The specified time period can be selected based on the time for the transmission of data and the time for the response with the authorisation message. If the data is sent directly over radio networks to the communication device and the vehicle, then the allowed total time from the request for access authorisation for the mobile communication device to the pairing of communication device and vehicle can be limited to a few seconds or to a few minutes. After this, authorisation expires and must be requested again. This process prevents the key information being read from keys in advance and ensures that access to the vehicle is significantly delayed.

It is preferred in this context that the authorisation message contain a time identifier, which is specified by the generation of the authorisation message or the validity period of the authorisation message.

The validity or revocation of the authorisation can be determined based on the time indicator. In addition, based on the time indicator, manipulation of the timing can be detected if a comparison is made with the system time of the vehicle on the one hand and the communication device on the other.

The method of the invention will now be explained with reference to the accompanying drawings.

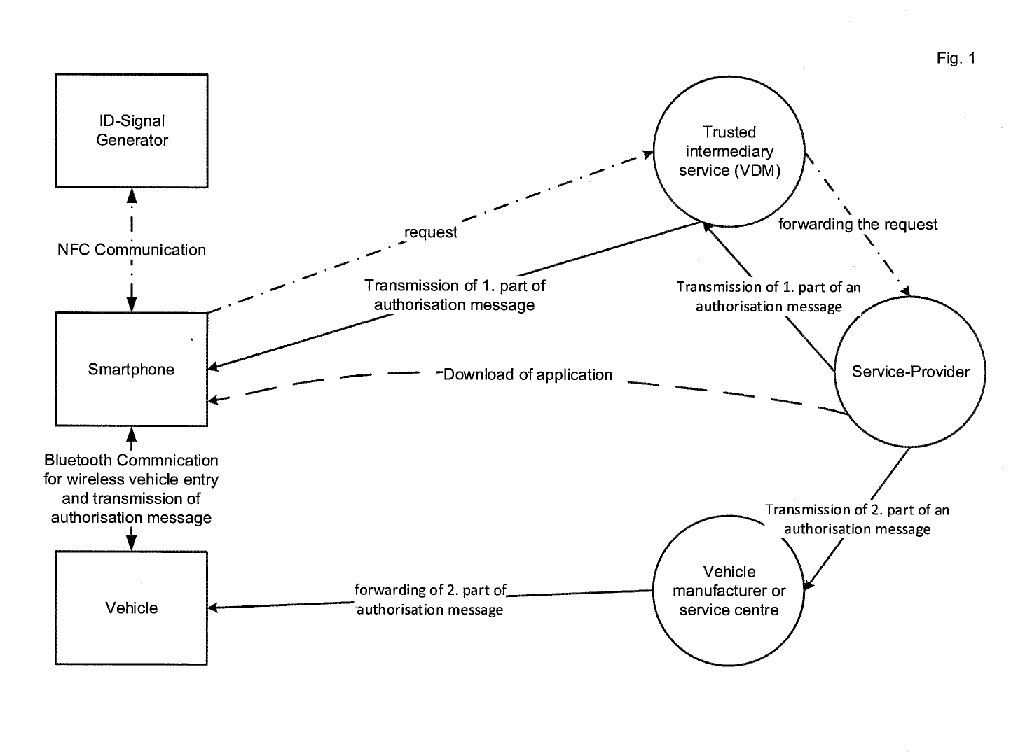

FIG. 1 shows a schematic overview of the interaction of the individual components in the implementation of the method according to a first embodiment.

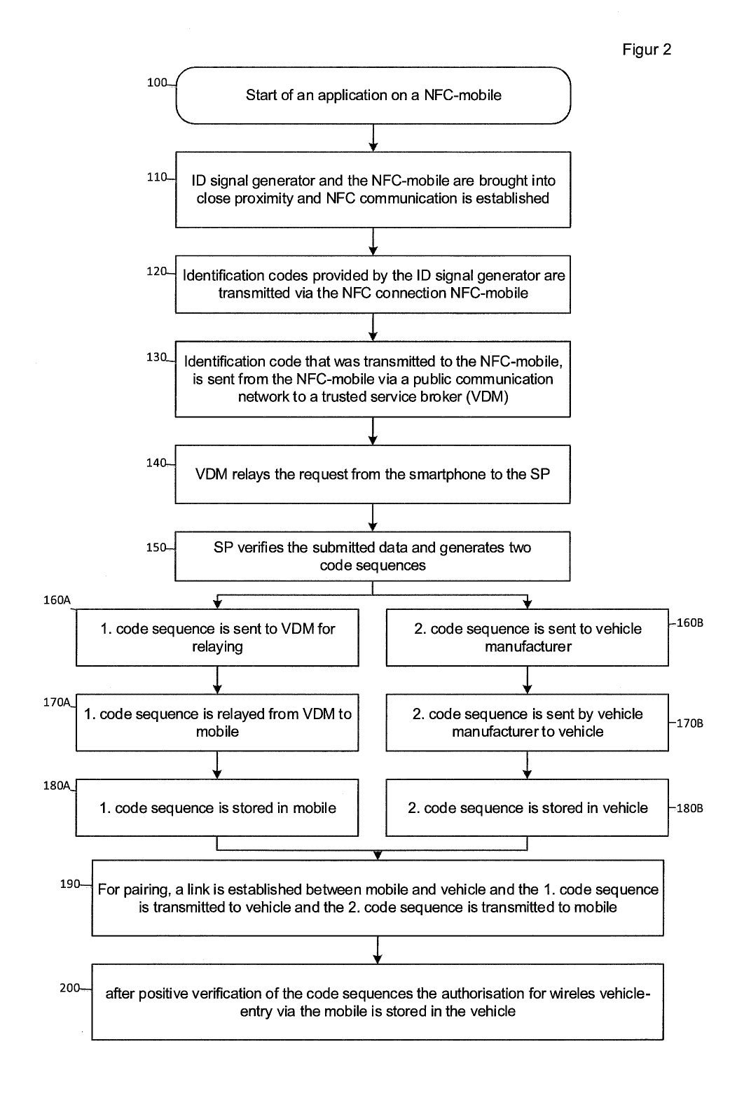

FIG. 2 shows a flow diagram of the process according to the first embodiment.

FIG. 1 shows the devices involved in the process and their interaction. An ID signal generator (10) for motor vehicles, a smartphone (20) and a vehicle (30) form the physical functional units of the process. The participants in the process, represented by circles, are the trusted intermediary service (VDM) (40), the service provider (SP) (50) and the vehicle manufacturer or its service centre (60). These latter facilities may symbolise complex functional system, which may also be spread across large functional and geographic areas.

The trusted intermediary service (VDM) is responsible for managing the contact data between users and service providers. Here, the VDM can provide secure management and provisioning of applications that have been published by the service provider.

To this end, the VDM can cooperate with the operators of communications networks and meets specific requirements for certification and trustworthiness.

The physical process participants are alternately in communication. An NFC connection 15 can thus be established between the ID signal generator (10) and the smartphone (20). A Bluetooth connection (25) can be established between smartphone (20) and vehicle (30).

These lines of communication are short-range radio communications. In contrast, the smartphone can establish a communication connection to the VDM and/or SP via long-range communication networks. These are, for example, mobile phone networks or the Internet.

FIG. 2 shows the interaction of the units from FIG. 1 as a flow diagram.

Before the process is feasible, an appropriate application to handle communication between smartphones (15) and the ID signal generator (10) and further communication requests is installed on the smartphone (10). This can be done by requesting the corresponding application from an available online database or by pairing the smartphone (20) with corresponding storage media, on which the application is stored. The application can be adapted to the smartphone as well as to the specific type of vehicle or even to the specific ID signal generator.

In step 100 of FIG. 2, this application is activated on the smartphone (20) The ID signal generator (10) and the smartphone (20) are brought into close proximity and NFC communication (15) is established in step (110). The workflow of the application on the smartphone (20) causes identification codes provided by the ID signal generator (10) via the NFC connection (15) to be transmitted to the smartphone (20) This occurs in step (120) in FIG. 2. These data are immediately validated on the smartphone (20) to eliminate transmission errors and to verify the compatibility of the smartphone and the corresponding application on the smartphone with the ID signal generator (10).

In step (130), the identification code that was transmitted by the ID signal generator (10) to the smartphone (20), is sent from the smartphone (20) via a public communication network to a trusted service broker (VDM) (40). The function of a VDM is to provide security in the provision of services using globally usable networks. Such VDM-provided functions are known from online payment transactions. The VDM is a kind of interconnect between the actual service provider and the end user.

In step (140), the VDM (40) relays the request from the smartphone (20) to the SP (50). This SP then verifies the submitted data, in particular the identification codes provided. Using the unique identification code of the key or identification signal generator (10), the service provider (50) can access the corresponding vehicle data for the vehicle (30) and generates a multi-line code sequence in step (150), which is customised both for the vehicle (30) and the smartphone (20) and which considers the data from the ID signal generator (10).

A part of the code sequence is now sent back to each of the devices to be paired via different lines or communication. A first part of the code sequence is in turn transmitted by the SP (50) to the smartphone (20) via the VDM (40). This occurs in steps (160A), (170A) and (180A). The first code sequence is saved on the target device, the smartphone (20).

A second code sequence is sent by the SP (50) to the vehicle manufacturer (60) in step (160B), based on the data that the SP (50) has determined for the vehicle (30) based on the identification code. In step (170B), the vehicle manufacturer (60) transmits the second code sequence to the vehicle (30). This can be done while the vehicle is at a service centre by the connecting an appropriate service device, or through a wireless communication via a public communication network, provided the vehicle (30) is equipped with the appropriate means of communication.

In step (180B), the second code sequence is stored in the vehicle.

After this sequence of steps, the first code sequence is stored in the smartphone (20), while the second code sequence is stored in the vehicle (30). In the subsequent pairing process (190) between smartphone (20) and the vehicle (30), the code sequences are transmitted and verified, and the paring authorisation (200) is generated after positive verification of the code sequences.

The thereby required communication between the smartphone and the vehicle can be done using a wire, however, a Bluetooth connection can also be initiated for wireless transmission. After successful pairing of the both components of smartphone and vehicle (30), the access authorisation of the smartphone is stored in the motor vehicle control device (step 200). Subsequently, the smartphone can access the enabled features of the vehicle, even completely without the presence of the ID signal generator.

The security of the method according to the invention can be increased even further if the possession of the smartphone (20) by the legitimate owner of the motor vehicle (30) must be registered before any pairing may be carried out. To do this, the owner can, for example, pre-register his or her smartphone (20) as a legitimate communication device by calling or sending an SMS to a specified number from the smartphone (20) if he or she provides information known only to the owner via this smartphone. This can be, for example, information or an identifier that is transmitted to the smartphone by the vehicle via a Bluetooth connection managed by the application, whereby the legitimate ID signal generator must be in the motor vehicle's ignition lock at the time. In this state, the control device of the motor vehicle transmits a unique identifier via the Bluetooth connection to the smartphone, which is sent to the SP as an additional identification code in the execution of the method in accordance with the invention. This ensures that the smartphone is actually authorised as a legitimate means for the execution of the appropriate authorisation process according to the invention in a situation that is controlled by the user.

1. A method for providing wireless vehicle access to a motor vehicle, comprising the steps:
establishing a connection between an ID signal generator associated with the motor vehicle and a wireless communication device,
transmission of a first identification code stored in the ID signal generator from the ID signal generator to the communication device,
establishment of a connection via a public communication network between the wireless communication device and a service provider and
transmission of the first identification code from the wireless communication device to the service provider, together with a second identification code that identifies the wireless communication device,
generation of a multi-part authorisation message by the service provider,
transmission of portions of the authorisation message to the wireless communication device,
transmission of portions of the authorisation message to a control device in the motor vehicle,
establishment of a connection between the wireless communication device and the control device in the motor vehicle and verification of the access authorisation of the communication device based on the parts of the authorisation message from the motor vehicle and the communication device.

2. Method according to claim 1, wherein the connection between the ID signal generator and the wireless communication device is a short-range radio connection, for example a connection in accordance with the NFC standard.

3. Method according to claim 1, wherein the connection between the wireless communication device and the control device in the vehicle is a short-range radio connection, for example a connection in accordance with the Bluetooth standard.

4. Method according to claim 1, wherein the communication device is stored as an authorised access device in the control device of the motor vehicle by means of a unique identification code upon positive authentication of the access authorisation.

5. Method according to claim 1, wherein the parts of the authorisation message are transmitted to the control device in the motor vehicle via a public mobile communications network.

6. Method according to claim 1, wherein the parts of the authorisation message is transmitted to the control unit in the motor vehicle by means of a service unit that can be paired with the control device.

7. Method according to claim 1, wherein an executable application, which is transferable to the wireless communication device, is retrievable from the service provider for the management of the connection between the ID signal generator and the wireless communication device.

8. Method according to claim 1, wherein the authentication message is determined by the additional inclusion of a vehicle identification from the identification code of the ID signal generator.

9. Method according to claim 1, wherein prior to establishing a connection over a public communication network between the wireless communication device and a service provider, a master key is stored as a further identifier in the communication device, and this is transmitted along with the first identification code and the second identification code from the wireless communication device to the service provider.

10. Method according to claim 1, wherein the establishment of the connection between the wireless communication device and the control device of the motor vehicle takes place within a predetermined time period from the transmission of the identification data from the wireless communication device to the service provider.

11. Method according to claim 10, wherein the authorisation message includes a time indicator that indicates the generation of the authorisation message, or the validity period of the authorisation message.
